(19) United States
(12) Patent Application Publication
(10) Pub. No.: US 2008/0181989 A1
(43) Pub. Date: Jul. 31, 2008

(54) Method of producing vegetable based beverages

(76) Inventors: Joan Thomas, Miramar, FL (US); Ronald Thomas, Miramar, FL (US)

Correspondence Address: Ronald Thomas, 14280 BLUE GILL ROAD, MIRAMAR, FL, 33027, US

(21) Appl. No.: 11/699,535

(22) Filed: Jan. 30, 2007

(51) Int. Cl. A23L 1/302; A23L 1/48; A23L 1/20; A23L 1/212

(52) U.S. Cl. 426/72; 426/507; 426/511

(57) ABSTRACT

The process and formula disclosed herein can be used to produce a nutrient-rich, all natural beverage product using chick peas or butternut squash as the primary ingredient. The formulation and process of this invention results in a nutrient-rich beverage that has a delicious flavor and frozen “smoothie” consistency. The production process involves the softening of a quantity of vegetable such as chick peas, butternut squash or chana dal via soaking or steaming. This is followed by pulverizing said vegetable base, which is then admixed with vanilla abstract, aromatic bitters and soy milk. This is followed by admixing either (1) flax seed, condensed milk, nutmeg, and vitamin C; or (2) nutmeg and flax seed, or (3) stevia based upon the vegetable type used. The resulting admixture is then frozen immediately and stored in a frozen state.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER LISTING COMPACT DISK APPENDIX

Not Applicable

### BACKGROUND OF THE INVENTION

This invention is related to the formulation of plant-based beverages that provide nutritional benefits. None of these references show this process or formulation for a chick pea or butternut squash-based beverage as presented herein.

### BRIEF SUMMARY OF THE INVENTION

The process and formula disclosed herein can be used to produce a nutrient-rich, all naturally-sweetened beverage product using chick peas or butternut squash as the primary ingredient. This formulation and process provides the following advantages not presented in prior art: (a) the formulation of a beverage from chick peas or butternut squash or Chana Dal; (b) a uniquely refreshing beverage featuring a texture similar to both a milkshake and a frozen juice smoothie; and (c) a beverage that can act as nutritional dietary supplement and assist in the treatment of ailments and weight control.

### BRIEF DESCRIPTION OF THE SEVERAL VIEWS OF THE DRAWING

FIG. 1 depicts flow chart of the beverage production process.

### DETAILED DESCRIPTION OF THE INVENTION

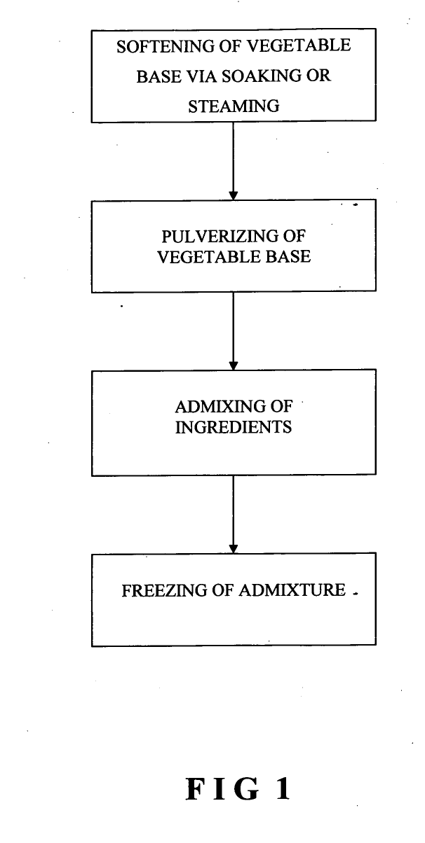

The method illustrated in FIG. 1 produces a beverage in a manner that retains the full nutrient content of the vegetable base, adds a combination of natural ingredients that imparts flavor and sweetness, and imparts a semi-frozen texture. Step A of this method producing a vegetable-based beverage begins by softening a quantity of either chick peas, butternut squash or Chana Dal via a process of soaking in purified water overnight or steaming for approximately twenty minutes. Step B creates the vegetable base through pulverizing the softened chick peas, butternut squash or Chana Dal using a food processing device such as a blender. Step C is the admixing to each 8 ounces of vegetable base about 4 ounces purified water, about 0.166 ounces almond extract, about 0.083 ounces vanilla extract, about 0.020 ounces aromatic bitters and about 3 ounces soy milk. This is followed by admixing of either of the following single or multiple alternate ingredient additives to the aforementioned vegetable base admixture comprising:
a) about 0.500 ounces flax seed, about 1.5 ounces condensed milk, about 0.021, ounces nutmeg, and about 0.042 ounces vitamin C; or
b) about 0.021, ounces nutmeg and about 0.500 ounces flax seed; or
c) about 0.042 ounces of stevia.

The embodiments of the present invention may, of course, be carried out in other ways than those set forth herein without departing from the spirit and scope of the invention. The present embodiments are, therefore, to be considered in all respects as illustrative.

What is claimed:

1. A method for producing beverages which comprises:
a) softening a quantity of a vegetable base such as either chick peas, butternut squash or Chana Dal and the like, via a process of steaming or soaking overnight in water; and
b) pulverizing the softened vegetable base using a manual or automated food processing means.

2. A method for producing beverages according to claim 1 followed by:
a) admixture of the chick pea vegetable base with purified water, flax seed, almond extract, vanilla extract, aromatic bitters, soy milk, condensed milk and vitamin C so that any given quantity of the final product contains the approximate ingredient proportions of 50% pulverized chick pea vegetable base, 25% purified water, 3.125% flax seed, 4.125% almond extract, 0.518% vanilla extract, 0.125% aromatic bitters, 18.750% soy milk, 9.375% condensed milk, 0.131% nutmeg, and 0.263% vitamin C;
b) admixture of the butternut squash vegetable base with purified water, almond extract, vanilla extract, aromatic bitters, soy milk, condensed milk and nutmeg so that any given quantity of the final product contains the approximate ingredient proportions of 50% butternut squash vegetable base, 25% purified water, 4.125% almond extract, 0.518% vanilla extract, 0.125% aromatic bitters, 18.750% soy milk, 9.375% condensed milk and 0.131% nutmeg; and
c) admixture of the Chana Dal vegetable base with purified water, flax seed, almond extract, vanilla extract, aromatic bitters, soy milk and stevia so that any given quantity of the final product contains the approximate ingredient proportions of 50% Chana Dal vegetable base, 25% purified water, 3.125% flax seed, 4.125% almond extract, 0.518% vanilla extract, 0.125% aromatic bitters, 18.750% soy milk and 0.263% stevia.

3. A method according to claims 1 and 2, followed by immediate and continual freezing of the resulting admixture as a texture-enhancing and preservative process.
